(19) United States
(12) Patent Application Publication
(10) Pub. No.: US 2009/0101002 A1
(43) Pub. Date: Apr. 23, 2009

(54) CLOSED WAVE SHAPED GROOVE

(75) Inventor: Arieh Sher, Rehovot (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: ARIOMEDICA LTD., Tel Aviv (IL)

(21) Appl. No.: 12/301,029

(22) PCT Filed: Mar. 15, 2007
(86) PCT No.: PCT/IL07/00339

§ 371 Date: Nov. 16, 2008

Related U.S. Application Data
(60) Provisional application No. 60/803,628, filed on Jun. 1, 2006.

(51) Int. Cl. F16H 25/08

(52) U.S. Cl. 92/31; 74/25; 74/48

(57) ABSTRACT

A mechanism transforms a longitudinal reciprocation movement of a piston in a cylinder into a combined unidirectional rotation and reciprocating movement of the piston. In order to achieve this transformation the piston includes a closed wave shaped groove on its circumference. The closed wave shaped groove has recesses at its apexes. The recesses break the symmetry of the groove. Balls that are located in the cylinder protrude into the groove. When the piston is reciprocating, the groove slides on the balls. A flexible heat shrink ring secures the balls in place and assures that the balls are constantly biased toward the face of the groove.

### FIELD AND BACKGROUND OF THE INVENTION

The present invention relates to mechanical systems that use a closed wave shape groove mechanism systems that use a closed wave groove to transform longitudinal movement of a first element into rotational movement of a second element when the interface of mechanical linkage between the first and second elements includes a closed groove and, in particular, it concerns an improved closed wave shaped groove mechanism.

Such closed wave shaped groove mechanisms are know in the art and specifically described in U.S. Pat. Nos. 5,350,390, 5,806,404 and PCT application IL2003/00807 all to the present inventor. The disclosures of these patents and application are incorporated herein by reference in their entirety.

### SUMMARY OF THE INVENTION

The present invention is an improved closed wave shaped groove mechanism.

It is the object of the present invention to provide a closed wave shaped groove that ensures unidirectional rotation of the piston.

It is another object of the present invention to provide a closed wave shaped groove that is suitable for manufacturing in small size parts such as in atherectomy devices.

It is another object of the present invention to provide a closed wave shaped groove that is easy to manufacture.

It is another object of the present invention to provide a mechanism in which the balls are in contact with the surface of the groove along the entire path.

It is another object of the present invention to provide a mechanism in which a flexible ring will compensate for manufacturing tolerances.

It is another object of the present invention to provide a mechanism that is easy to assemble.

According to the teachings of the present invention there is provided, a mechanism for transforming the reciprocating movement of a piston into a combination of unidirectional rotation and reciprocating movement of the piston, the mechanism comprising a closed wave shaped groove configured in a circumferential surface of the piston such that the closed wave shaped groove includes at least one anomaly configured render the closed wave shaped groove asymmetrical, and the anomaly includes a recess configured in at least one apex of the closed wave shaped groove.

According to a further teaching of the present invention, the recess is configure so as to limit the direction of piston rotation to the unidirectional rotation.

According to a further teaching of the present invention, the anomaly produces double asymmetry in the closed wave shaped groove.

According to a further teaching of the present invention, at least one apex of the closed wave shaped groove contains a recess configured is a groove segment that extends parallel to the axis of the piston.

According to a further teaching of the present invention, at least a portion of a groove segment extending from the at least one apex has a varied depth so as to slope outwardly from an axis of the piston as a function of a distance from the apex.

There is also provided according to the teachings of the present invention, a mechanism for transforming the reciprocating movement of a piston into a combination of unidirectional rotation and reciprocating movement of the piston, the mechanism comprising: (a) a closed wave shaped groove configured in a circumferential surface of the piston; and (b) at least one ball element deployed so as to extend at least partially into the closed wave shaped groove; wherein the at least one ball element is secured in place and biased toward the face of the groove by a resilient ring.

According to a further teaching of the present invention, there is also provided a cylinder element in which the piston is deployed, the circumferential outer surface of the cylinder element having a non-circular closed curve contour.

According to a further teaching of the present invention, the non-circular closed curve contour is an ellipse.

### BRIEF DESCRIPTION OF THE DRAWINGS

The invention is herein described, by way of example only, with reference to the accompanying drawings, wherein:

FIG. 1a is a planar view of a symmetric closed wave shaped groove;

FIG. 1b is a 3D view of a symmetric closed wave shaped groove;

FIG. 2a is a planar view of an asymmetric closed wave shaped groove of one preferred embodiment that has a recess at the apex;

FIG. 2b is a cross sectional view of an asymmetric closed wave shaped groove of one preferred embodiment, taken along Line A-A of FIG. 2a;

FIG. 2c is a 3D view an asymmetric closed wave shaped groove of one preferred embodiment;

FIG. 3a is a planar view of another preferred embodiment having a double asymmetric closed wave shaped groove;

FIG. 3b is a cross sectional view of another preferred embodiment having a double asymmetric closed wave shaped groove taken along Line B-B of FIG. 3a;

FIG. 3c is a 3D view of another preferred embodiment having a double asymmetric closed wave shaped groove;

FIG. 4a is an exploded view of the mechanism before assembly;

FIG. 4b is a longitudinal cross sectional view of the assembled mechanism; and

FIG. 4c is a cross sectional view of the assembled mechanism along line 4c-4c in FIG. 4b.

### DESCRIPTION OF THE PREFERRED EMBODIMENTS

The present invention is an improved closed wave shaped groove mechanism.

The principles and operation of an improved closed wave shaped groove mechanism according to the present invention may be better understood with reference to the drawings and the accompanying description.

By way of introduction, the present invention is directed to improvement of the closed wave shaped groove mechanism in which the groove is defined on the circumferential surface of a piston and includes helical segments that have alternating slopes. The alternating helical segments are joined at their apexes. The alternating apexes, therefore, represent the sequential crests and troughs of a typical wave form. As used herein, the phrase “closed wave shaped groove” refers to a groove configured in the face of a substantially cylindrical surface where the groove follows a substantially wave shaped path that closes on itself so as to form a single continuous groove. As used herein, the phrase “wave segment” refers to a section of the path of the groove that extends between two apexes.

The basic concept of this mechanism is to transform a reciprocating longitudinal movement into a combined reciprocating longitudinal and unidirectional rotation movement so that a drill bit or a cutter that is attached to the mechanism will perform the same combined longitudinal and continuous unidirectional rotation movement. It is important that the movement will be unidirectional in order to minimize the possibility that debris will be scattered in the blood vessel. In the atherectomy device described in U.S. Pat. No. 5,350,390 and PCT application IL2003/00807 the atheroma is excised by the sharp edges of the cutter, squeezed into the cutter and then removed by vacuum outside the body via a central lumen in the catheter. If the movement of the cutter is not unidirectional there is a risk that the excised debris of the atheroma will be dispersed in the blood vessel rather then being squeezed into the cutter. This situation is dangerous to the patient since the debris may flow distally in the artery and block the blood stream.

The above referenced patents and application describe various provisions of the mechanism that force the piston to rotate in one direction. In U.S. Pat. No. 5,350,390 a sloped cutout at the groove apexes is shown. U.S. Pat. No. 5,806,404 describes resilience means that act directly on the ball and also a ratchet mechanism that is located longitudinally apart from the closed wave shaped groove. PCT application IL2003/00807 describes a groove that is asymmetric at the apexes. All these embodiments share a groove path that is defined only on the circumferential surface of the piston, such that all the points of the defining path (trajectory) of the groove are located at the same distance from the axis of the piston. That is to say, the closed wave groove previously disclosed has a uniform depth along its entirety. The present invention relates to a closed wave groove in which various points of the defining path are located at different distances from the piston axis. That is to say, the depth of the closed wave groove of the present invention varies along its length.

In the preferred embodiment the groove is formed using a ball end mill. However, other groove cross sectional contours are possible, such as but not limited to, a V shaped groove. It should be noted that a V shape groove will ease the ball rotation in the groove.

Preferably at least two balls are deployed within the groove; however, this number should not be considered a limitation of the scope of the present invention and therefore, substantially any number of balls may be employed. It is preferred to use a high hardness material in order to allow the ball to slide smoothly in the groove and not damage the groove.

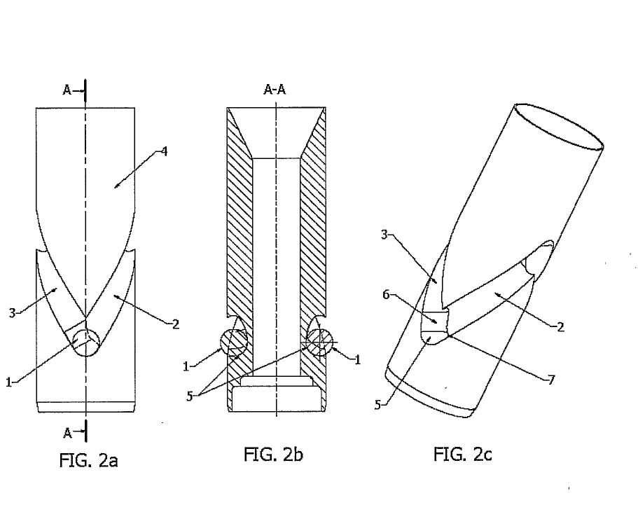

The groove of the present invention is configured such that each of the apexes of the groove segments in anomaly that renders the groove asymmetric. In a first preferred embodiment, which is discussed with regard to FIGS. 2a-2c, the groove of the present invention is configured such that each of the apexes of the groove segments is closer to the axis of the piston then the rest of the defining path, thereby creating recesses at each of the apexes. Thusly configured, a ball that moves within the groove will fall into a recess at the apex and will not be able to move backwards into the segment from which it came.

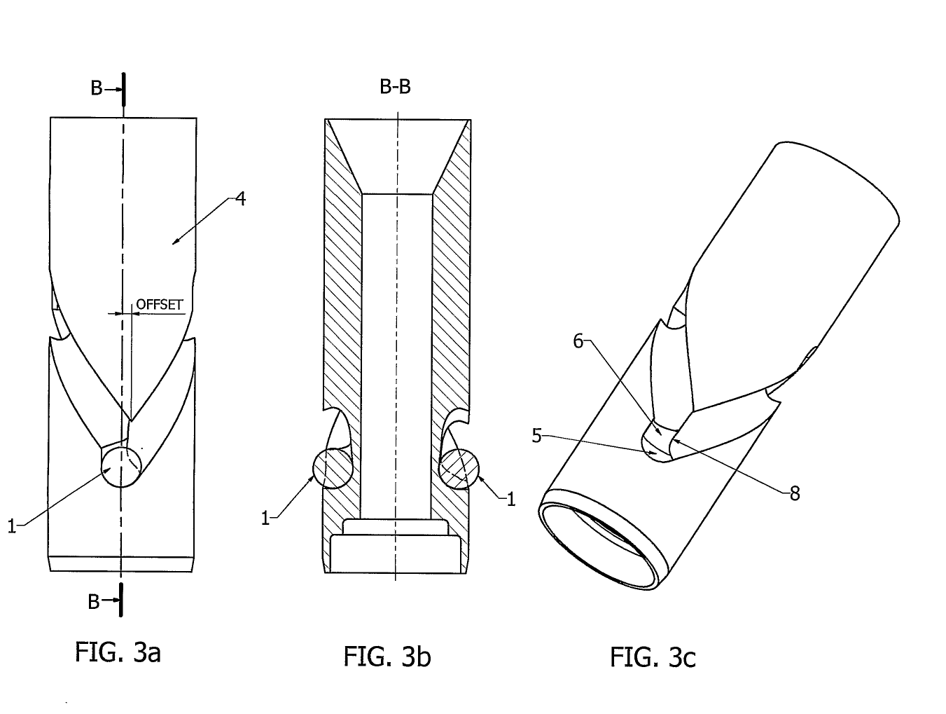

In a second preferred embodiment, which is discussed with regard to FIGS. 3a-3c, the anomaly of the groove of the present invention includes double asymmetry configured at each of the apexes of the groove segments.

This type of groove has several advantages in the medical field. It is advantageous over the solutions that include additional elements such as ratchet or resilient means, as there are space limitations due to the very small dimensions of the mechanism. This type of groove is easy to manufacture as it is created in one sweep of the cutting mill.

In order to assure that the balls are in contact with the surface of the groove along the entire path, a flexible ring pushes them against the groove.

Referring now to the drawings, it should be noted that while in actuality the ball is substantially stationary and it is the piston in which the groove is configured that slides over it, for ease of explanation, the ball is described as moving within the groove. Also, it will be appreciated that features of the groove may be varied dependent on particular applications. Therefore, although the figures herein illustrate a groove having four apexes, the wave length may be varied so as to increase or decrease the number of apexes. Further, the slope of the wave segments between apexes may be varied in order to change the range of reciprocating piston movement.

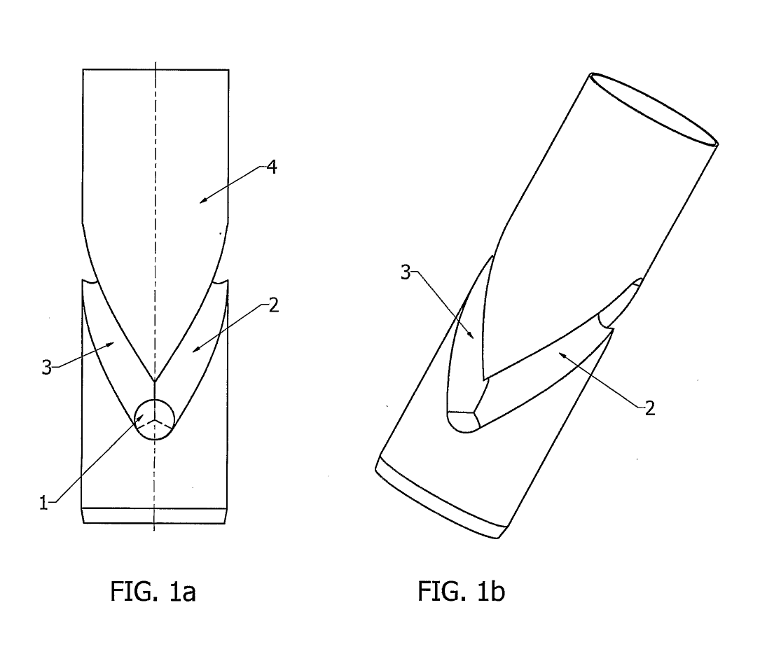

FIG. 1a and FIG. 1b illustrates a planar view and 3D view of a symmetric closed wave shaped groove. These figures are shown for reference only to emphasize the importance of the asymmetry at the groove apexes. In case the groove is symmetric at its apexes as shown in these drawings, ball (1) at the apex is located at a singularity point i.e., when the ball is pushed longitudinally it has no preference in which sloped segment of groove to move. It can either move to the right into the helix segment (2) or to the left into the helix segment (3). Thus, the rotation of piston (4) will be arbitrary. A cutter (not shown) that is attached to the piston (4) will perform the same arbitrary movement. As was mentioned earlier, if the movement of the cutter is not unidirectional there is a risk that the excised debris of the atheroma will not be squeezed into the cutter but rather will be cut and dispersed in the blood vessel. This situation is dangerous to the patient as the debris may flow distally in the artery and block the blood stream.

The embodiment illustrated in FIG. 2a, FIG. 2b and FIG. 2c is a first preferred embodiment of the present invention. At the apex of the groove, a recess (5) is added. The recess (5) joins helix segment (3) via slope (6). Ball (1) moves in the helix segment (2) until it reaches the groove apex where it falls into recess (5). When the ball is pushed longitudinally it cannot move backwards into helix segment (2) because right wall (7) of recess (5) prevents it. Ball (1) is forced to move along slope (6) that joins helix segment (3). Therefore, ball (1) always moves in the same direction. The end result of this is that the piston (4) and a cutter attached to it perform a unidirectional movement.

Illustrated in FIG. 3a, FIG. 3b and FIG. 3c is a second preferred embodiment of the present invention. Shown here is a groove that has double asymmetry at the apexes of the groove. This embodiment is a combination of the asymmetry caused by the recess, as described herein, and the asymmetry described in PCT application IL2003/00807. The asymmetry described herein is designated by the word “offset” in FIG. 3a. As seen, each of the apexes of the groove contains a segment (8) that extends parallel to the axis of the piston (4), and contains a recess (5), and a slope (6) that slopes outwardly from the axis of piston (4) so as to assist the ball (1) out of the recess (5). As illustrated here, only the parallel to the axis segment (8) is sloped. It should be noted, however, at least a portion, or even the entire length, of each helical segment, i.e., from apex to apex, can be configured with an outward slope. It will be understood that at least a portion of the groove segment extending from the apex has a varied depth that slopes outwardly from the axis of the piston as a function of the distance from the apex.

This type of construction is even better than the groove described with regard to FIG. 2a in assuring that ball (1) will always move in the same direction.

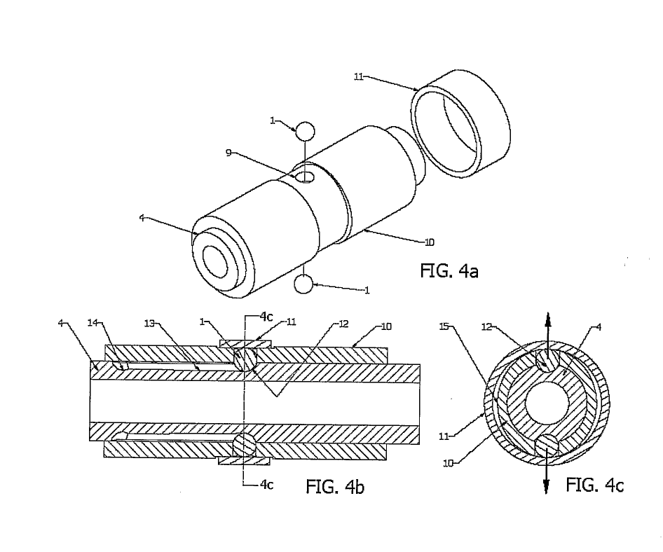

FIG. 4a and FIG. 4b illustrate the assembly of the mechanism. As shown here, two balls (1) are inserted via holes (9) in cylinder (10) such that they extend at least partially into groove (13). It will be appreciated that it is possible to replace the balls with, by non-limiting example, pins. A metal heat shrink ring (11) is shown in FIG. 4a before assembly on cylinder (10). Metal heat shrink ring elements are known in the art. As a non-limiting example some such are rings made from Nitinol that will start to shrink at 40 degrees C. An example is the Unilok ring manufactured by Intrinsic Devices, USA. FIG. 4b show the assembly after ring (11) is positioned on cylinder (10) and heated. It should be appreciated that the section illustrated in FIG. 4b is rendered here schematically for ease of understanding and that the true section has a more complicated shape.

As shown balls (1) are positioned in recess (12), thus they do not hinder ring (11) from shrinking fully. When piston (4) starts to move axially, balls (1) are forced to move on the slopped groove (13). The balls (1) are pushed radially outwardly, causing the ring to elastically deform. When balls (1) reach recess (13) they fall into it, with ring (11), which returns to its original shape, still pushing the balls (1) against the face of the groove. That is to say, the ring (11) biases the balls (1) toward the face of the groove.

Therefore, the elastic ring (11) keeps the balls (1) always in contact with the face of the groove. It is to be noted that the use of an elastic ring is also applicable for other applications, such as, by non-limiting example, the groove construction described in PCT application IL2003/00807 i.e., the groove without a recess at the apex. The advantage of using the elastic ring is ease of mechanism assembly.

FIG. 4c illustrates a variant embodiment of the mechanism of FIG. 4a and FIG. 4b. The cross section of cylinder (10) at the location of ring (11) can be circular. Alternatively, as shown here, the circumferential contour (15) of cylinder (10) has an elliptical shape. It is clear that when two equal and opposite radial forces are outwardly exerted on a free ring (see arrows in FIG. 4c), the circular shape of the ring will become elliptical, where the major axis of the ellipse is along the action line of the radial forces. Therefore, if the circumference (15) of cylinder (10) is manufactured with an elongated shape, such as, by non-limiting example, an ellipse, it will reduce the stresses placed on ring (11) and thereby, the stresses and displacements in cylinder (10). It will be appreciated that elliptical contour herein describe is used as a non-limiting example and that substantially any non-circular closed curve contour is within the scope of the present invention.

It will be appreciated that the above descriptions are intended only to serve as examples and that many other embodiments are possible within the spirit and the scope of the present invention.

1. A mechanism for transforming the reciprocating movement of a piston into a combination of unidirectional rotation and reciprocating movement of the piston, the mechanism comprising a closed wave shaped groove configured in a circumferential surface of the piston such that said closed wave shaped groove includes at least one anomaly configured render said closed wave shaped groove asymmetrical, and said anomaly includes a recess configured in at least one apex of said closed wave shaped groove, and at least a portion of a groove segment extending from said at least one apex has a varied depth so as to slope outwardly from an axis of the piston as a function of a distance from said apex.

2. The mechanism of claim 1, wherein said recess is configured so as to limit the direction of piston rotation to the unidirectional rotation.

3. The mechanism of claim 2, wherein said anomaly produces double asymmetry in said closed wave shaped groove.

4. The mechanism of claim 3, wherein at least one apex of said closed wave shaped groove contains a recess configured is a groove segment that extends parallel to the axis of the piston.

5. (canceled)

6. A mechanism for transforming the reciprocating movement of a piston into a combination of unidirectional rotation and reciprocating movement of the piston, the mechanism comprising;
(a) a closed wave shaped groove configured in a circumferential surface of the piston; and
(b) at least one ball element deployed so as to extend at least partially into said closed wave shaped groove;
wherein said at least one ball element is secured in place and biased toward the face of the groove by a heat shrink ring.

7. The mechanism of claim 6, further including a cylinder element in which said piston is deployed, a circumferential outer surface of said cylinder element having a non-circular closed curve contour.

8. The mechanism of claim 6, wherein said non-circular closed curve contour is an ellipse.

9. The mechanism of claim 5, wherein said heat shrink ring is fabricated from Nitinol.
